(19) United States
(12) Patent Application Publication
(10) Pub. No.: US 2006/0287899 A1
(43) Pub. Date: Dec. 21, 2006

(54) Computer-implemented method, system, and program product for conducting a trade-off study

(75) Inventors: Laurent L. Balmelli, White Plains, NY (US); Julia Rubin, Rechasim (IL)

Correspondence Address: HOFFMAN, WARNICK & D'ALESSANDRO LLC, 75 State Street, 14th Floor, ALBANY, NY, 12207, US

(73) Assignee: International Business Machines Corporation, Armonk, NY (US)

(21) Appl. No.: 11/157,257

(22) Filed: Jun. 21, 2005

(51) Int. Cl. G06F 17/50

(52) U.S. Cl. 705/7

(57) ABSTRACT

A method, system, and program product for conducting a trade-off study are described. Under aspects of the present invention, a mapping of logical model to a physical model for a product that is a subject of the trade-off study is provided. Based on the mapping, component(s) for a configuration of the product will be selected from a semantic component library, which is a resource that identifies available components and possible connections there between. For each component selected, an instance will be generated and then graphically connected to other instances. Parameters can then be designated for the connected instances. Once the configuration has been built in this manner, it can be evaluated and revised as needed.

### BACKGROUND OF THE INVENTION

1. Field of the Invention

In general, the present invention relates to a computer-implemented method, system, and program product for conducting a trade-off study. Specifically, the present invention provides a software-based tool to build, evaluate and update trade-off study configurations for products.

2. Related Art

In industry, manufacturers are constantly faced with making difficult decisions in deciding what components (e.g., parts) to include in a particular product. Often, such difficulty is compounded by the number of options that could exist for a particular component. For example, an automobile manufacturer could have several engines from which to select when designing a new car model. In most cases, the decision of which component to use is made based on a cost-benefit analysis in which the functional advantages provided by certain components are weighed against their cost and desirability to consumers. To this extent, trade-off studies are rapidly becoming an integral part of the business world.

In general, a trade-off study for a particular product will set forth its components (e.g., parts) and their respective costs and benefits. Unfortunately, existing approaches for compiling and conducting trade-off studies rely heavily on manual efforts. Specifically, an individual conducting the study will typically select components and gather the necessary data manually, and then represent the same in a document or the like. However, given that each product can have an extremely high volume of possible components the current approaches can be laborious and costly. This is especially the case since existing approaches require a designer to access large supplier catalogues to select components. Moreover, given the degree of reliance on manual efforts and information gathering, the existing approaches often lead to a high likelihood of duplication of effort and/or inaccuracies.

In view of the foregoing, there exists a need for a software-based tool that helps automate the generation and conducting of trade-off studies.

### SUMMARY OF THE INVENTION

In general, the present invention provides a computer-implemented method, system and program product for (generating and) conducting a trade-off study (e.g., for a product). Specifically, under the present invention a mapping of logical model to a physical model for a product is provided. The logical model typically sets forth a desired set of functionality for the product by representing an interaction of a set of logical (i.e. functional) components. The physical model sets forth one or more components (e.g., parts) for providing the desired set of functionality.

Once the mapping is provided, a configuration (i.e., a specific instance of a physical model) for the product is built. To build the configuration, component(s) will be individually selected from a semantic component library, which is a resource that identifies available components and possible connections there between. The semantic component library is built in advance and considered as an enterprise resource provided to the designers. An instance will be generated for each component selected, and then connected (e.g., graphically) to other instances (e.g., of other components). Thereafter, a set (e.g., one or more) of parameters can be set forth for the instance(s).

Once the configuration has been built in this manner it can be evaluated to conduct the trade-off study. Evaluation of the configuration can include any type of evaluation. For example, a cost model for the configuration could be evaluated, a cost-benefit analysis could be performed, a development effort could be evaluated, a complete verification of the mapping could be performed, etc. Based on the evaluation, the semantic component library and/or the configuration could be updated (e.g., components and/or connections could be changed), and then re-evaluated. In a typical embodiment, the present invention is embodied as a software-based tool that utilizes a modeling language such as the Uniform Modeling Language (UML) and the Systems Modeling Language (SysML).

A first aspect of the present invention provides a computer-implemented method for conducting a trade-off study, comprising: providing a mapping of a logical model to a physical model for a product that is a subject of the trade-off study; building a configuration for the product using a semantic component library, wherein the semantic component library identifies components for the product and potential connections between the components; and evaluating the configuration to conduct the trade-off study.

A second aspect of the present invention provides a system for conducting a trade-off study, comprising: a mapping system for providing a mapping of a logical model to a physical model for a product that is a subject of the trade-off study; a configuration system for building a configuration for the product using a semantic component library, wherein the semantic component library identifies components for the product and potential connections between the components; and an evaluation system for evaluating the configuration to conduct the trade-off study.

A third aspect of the present invention provides a program product stored on a computer useable medium for conducting a trade-off study, the computer useable medium comprising program code for causing a computer system to perform the following steps: providing a mapping of a logical model to a physical model for a product that is a subject of the trade-off study; selecting a component from a semantic component library, wherein the semantic component library identifies components for the product and potential connections between the components; creating an instance of the component; graphically connecting the instance with at least one other instance to yield the configuration; establishing a set of parameters for the instance; and evaluating the configuration to conduct the trade-off study.

A fourth aspect of the present invention provides a method for deploying an application for conducting a trade-off study, comprising: providing a computer infrastructure being operable to provide a mapping of a logical model to a physical model for a product that is a subject of the trade-off study; build a configuration for the product using a semantic component library, wherein the semantic component library identifies components for the product and potential connections between the components; and evaluate the configuration to conduct the trade-off study.

A fifth aspect of the present invention provides computer software embodied in a propagated signal for conducting a trade-off study, the computer software comprising instructions to cause a computer system to perform the following functions: provide a mapping of a logical model to a physical model for a product that is a subject of the trade-off study; build a configuration for the product using a semantic component library, wherein the semantic component library identifies components for the product and potential connections between the components; and evaluate the configuration to conduct the trade-off study.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for conducting a trade-off study according to the present invention.

FIG. 2 shows a functional diagram for conducting the trade-off study according to the present invention.

FIG. 3 shows an illustrative mapping of a logical model to a physical model according to the present invention.

FIG. 4 shows an illustrative semantic component library according to the present invention.

FIG. 5 shows the application of properties or stereotypes from the semantic component library to created instances according to the present invention.

FIG. 6 shows an illustrative graphical interconnection of component instances according to the present invention.

FIG. 7 shows the deployment of software to physical components according to the present invention.

FIG. 8A shows evaluation of a cost model according to the present invention.

FIG. 8B shows evaluation of a development effort according to the present invention.

FIG. 8C shows the evaluation of an allocation of a mapping according to the present invention.

It is noted that the drawings of the invention are not to scale. The drawings are intended to depict only typical aspects of the invention, and therefore should not be considered as limiting the scope of the invention. In the drawings, like numbering represents like terms between the drawings.

### DETAILED DESCRIPTION OF THE INVENTION

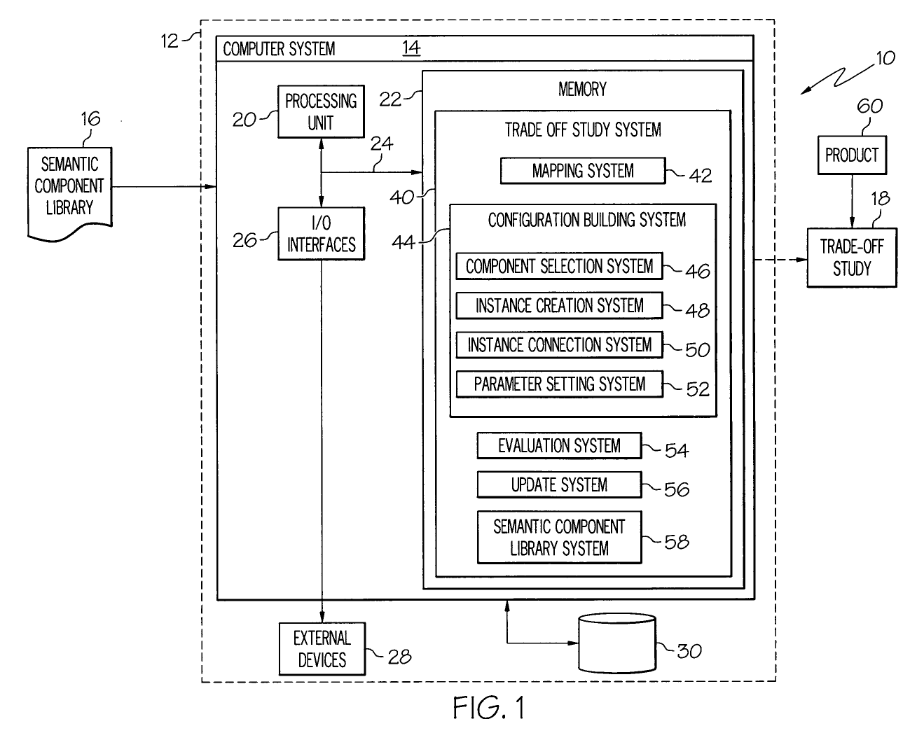

Referring now to FIG. 1, a system 10 for conducting a trade-off study 18 according to the present invention is shown. Specifically, system 10 depicts a software-based tool that automates the process of generating and conducting a trade-off study 18 for a product 60. In an illustrative embodiment, assume that product 60 is an automobile. However, this need not be the case. Rather, the teachings recited herein could be practiced in conjunction with any type of product.

In any event, as depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.) or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to conduct trade-off studies.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as trade-off study system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention such as semantic component library 16, trade-off study 18, evaluation(s), etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is trade-off study system 40, which includes mapping system 42, configuration building system 44, evaluation system 54, update system 56 and semantic component library system 58. As further shown, configuration building system 44 includes component selection system 46, instance creation system 48, instance connection system 50 and parameter setting system 52. It should be understood that the configuration of systems shown in FIG. 1 is intended to be for illustrative purposes only and that the functions of the present invention could be implemented with a different configuration.

In an illustrative embodiment, assume that trade-off study 18 is being conducted for a new automobile. As indicated above, in manufacturing products such as automobiles, manufacturers are often faced with making decisions over part/component selections. Such decisions often include weighing a benefit provided by a certain desired function and its necessary components against its cost, thus, necessitating a trade-off study. The present invention provides a tool and framework for automating the trade-off study process.

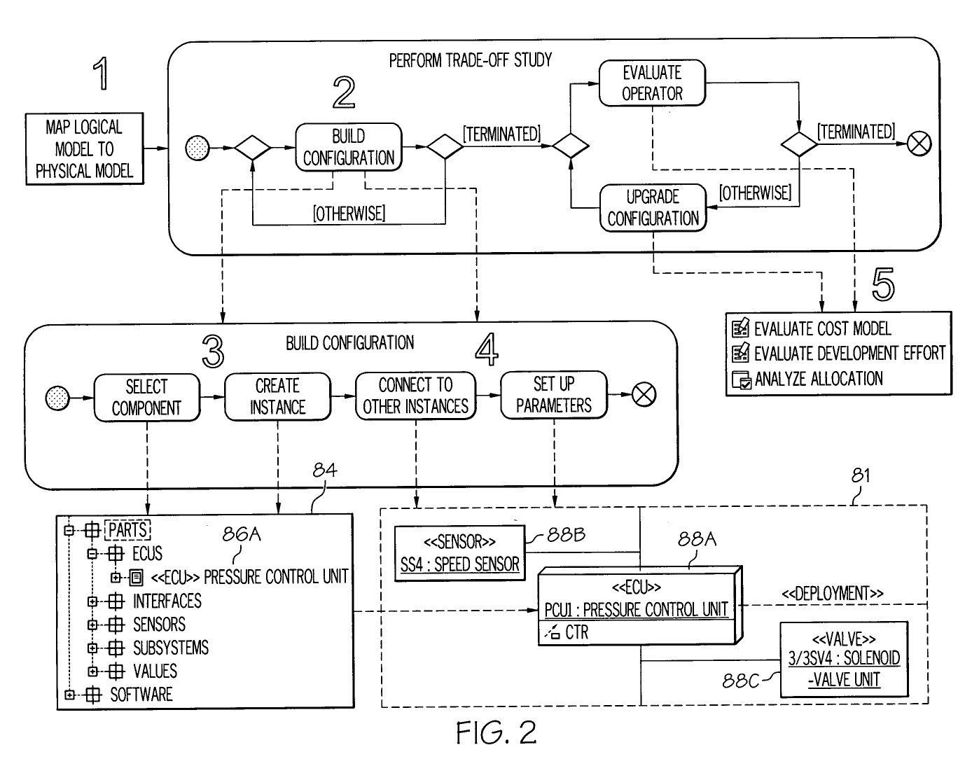

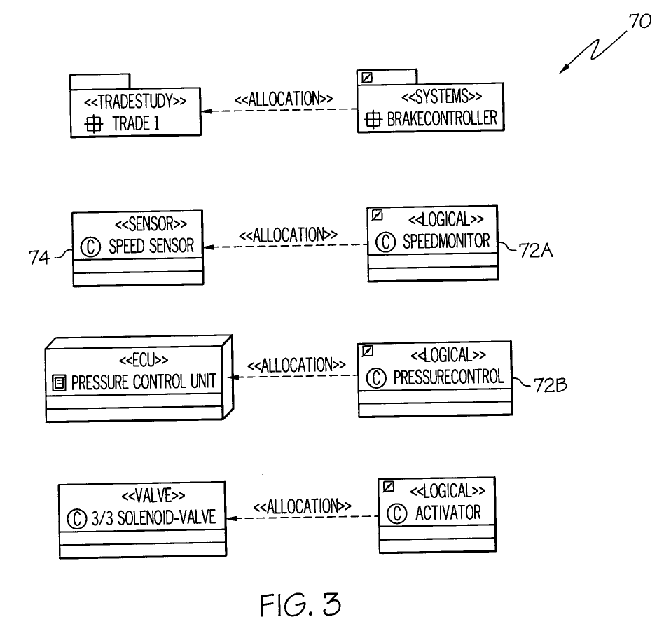

Referring now to FIGS. 1 and 2 collectively, the functions of the present invention will be discussed in greater detail. To initially build trade-off study 18, a logical model of product 60 will be mapped to a physical model. This is typically accomplished via mapping system 42. In mapping the logical model to the physical model, a user (not shown), will graphically associate desired functionality with any components (e.g., parts) needed to carry out the same. Referring briefly to FIG. 3, an illustrative mapping 70 is depicted. In mapping 70, logical models 72A-B are associated with physical model 74. Specifically, in the illustrative example shown, the automobile functions of “speed monitor” 72A and “pressure control” 72B are associated with the processor “speed sensor” 74. This indicates that component 74 will be used to provide functions 72A-B. Other desired functions will be mapped in a similar manner as shown throughout FIG. 3.

Referring back to FIGS. 1 and 2, once the mapping has occurred conducting/performance of the trade-off study can be commenced with the building of a configuration 81. Under the present invention configuration building system 44 will provide the automated tools for building configuration 81. Initially, component selection system 46 will be used to select one or more components from semantic component library 16. Under the present invention, semantic component library 16 identifies all available components (at least one component, or in a typical embodiment, a plurality of components) with any potential connections and/or relationships there between. To this extent, components can be arranged hierarchically within semantic component library 16.

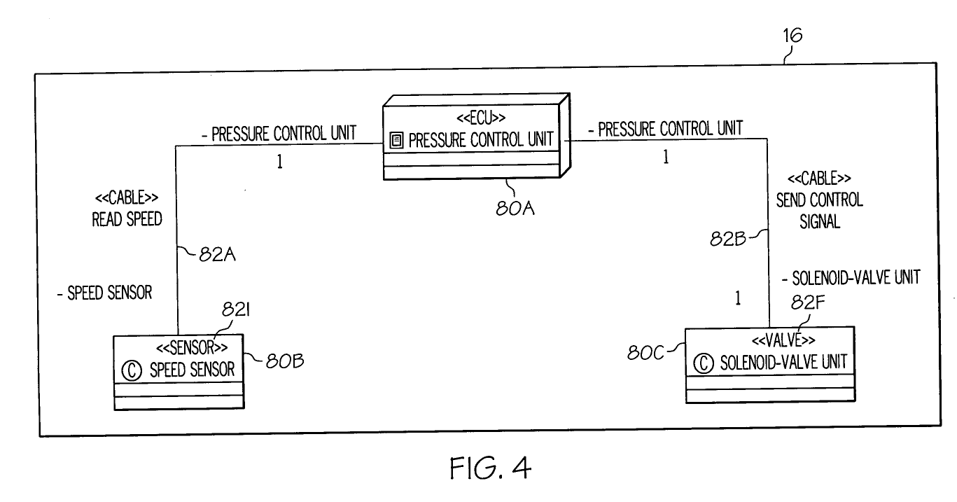

Referring to FIG. 4, a more detailed illustrative depiction of semantic component library 16 is shown. As depicted, semantic component library 16 includes components 80A-C. In addition, semantic component library 16 shows various possible connections 82A-B between components 80A-C. For example, component 80A is directly connectable to components 80B and 80C. Conversely, based on FIG. 4, component 80B cannot be directly connected to component 80C. Semantic component library 16 can also specify additional information. For example, semantic component library 16 could set for a cost of each component. Thus, semantic component library 16 sets forth any information needed about components needed to realize the desired product.

Referring back to FIGS. 1 and 2, it should be appreciated that semantic component library 16 can be constructed (e.g., in advance) via semantic component library system 58, which can allows an administrator or the like to identify the components, any connections between the components, as well as other pertinent information. In any event, as mentioned above, components for product 60 can be individually selected from semantic component library 16 (e.g., via component selection system 46 of FIG. 1). As specifically shown in FIG. 2, a graphical interface 84 could be provided from which specific component(s) can be selected. Interface 84 could include nodes or “selections” that correspond to a component. For example, “selection” 86A corresponds to a component referred to as “Pressure Control Unit.” Once a component is selected from interface 84, instance creation system 48 of FIG. 1 will create an instance thereof.

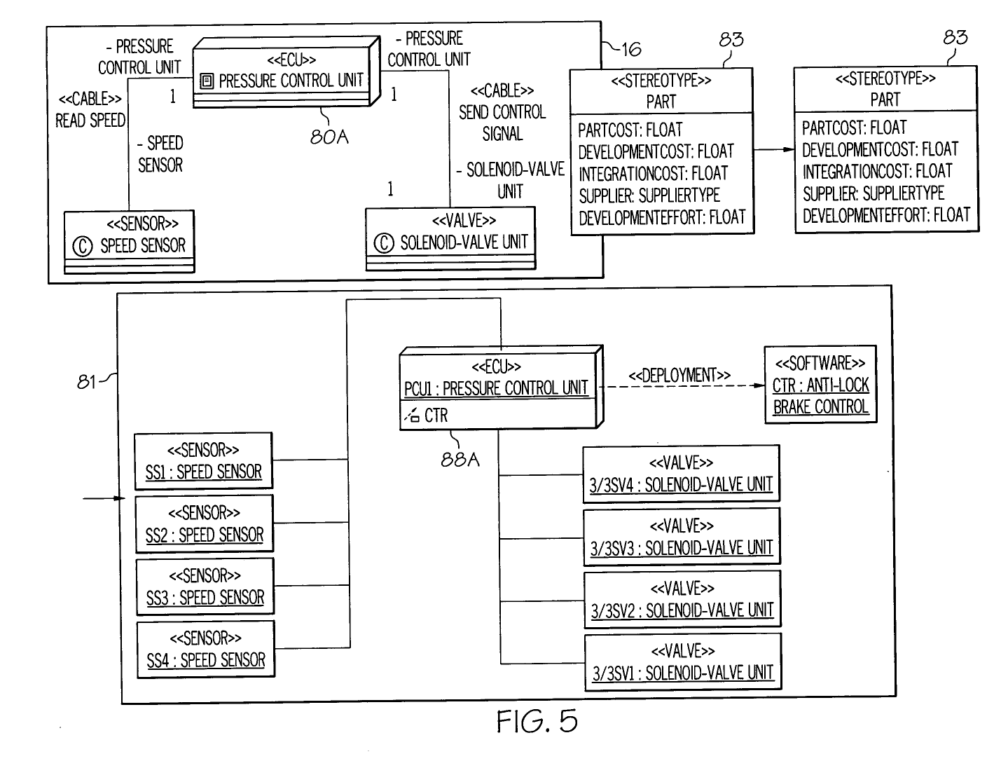

In creating an instance of a selected component, instance creation system 48 will apply any properties or “stereotypes” for the components contained in semantic component library 16 to the generated instances. Details of a component's “stereotype” could include, for example, its part cost, its development cost, its integration cost, is supplier, its development effort, etc. Referring to FIG. 5, this is shown in greater detail. Specifically, FIG. 5 shows a stereotype 83 for a component 80A in semantic component library 16 being applied to its corresponding instance 88A in configuration 81. This will allow a complete evaluation of configuration 81 to be performed (as will be further discussed below).

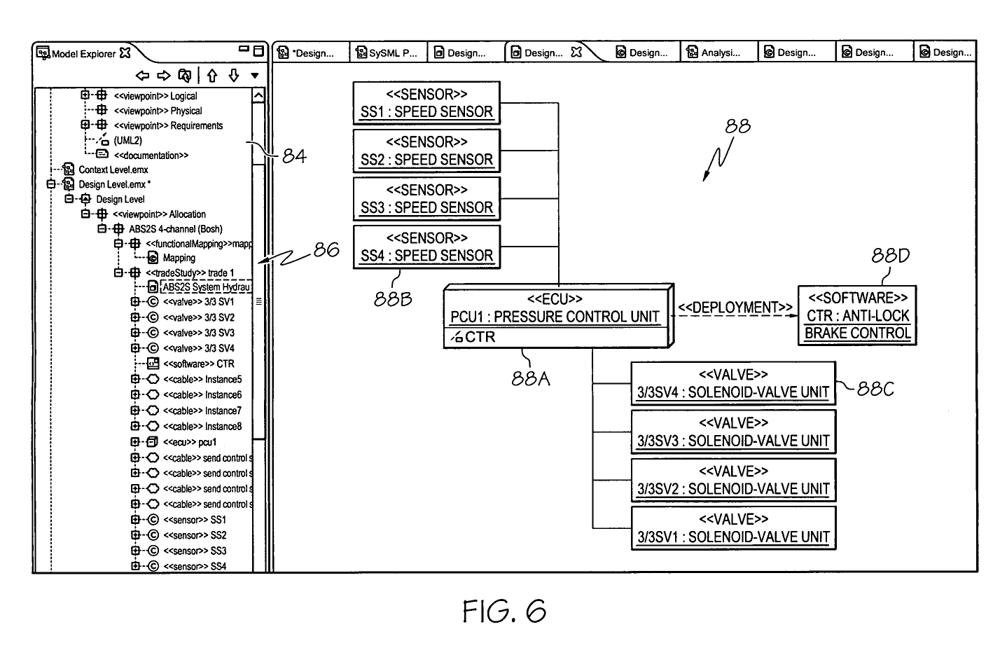

Once any stereotypes have been applied to created instances, instance connection system 50 will allow the created instance to be connected with other instances (e.g., for previously selected components). For example, as shown in FIG. 2, instance 88A, corresponding to “selection” 86A, was connected with instances 88B and 88C, which were created from “selections” previously made from interface 84. This process is shown in greater detail in FIG. 6. Specifically, referring to FIG. 6, interface 84 containing component “selections” 86 arranged hierarchically is shown. As further shown, instances 88A-D generated from selections have been interconnected. Typically, instance connection system 50 (FIG. 1) will only allow permissible connections between instances 88A-D, based on the information contained in semantic component library 16 (FIGS. 1 and 4).

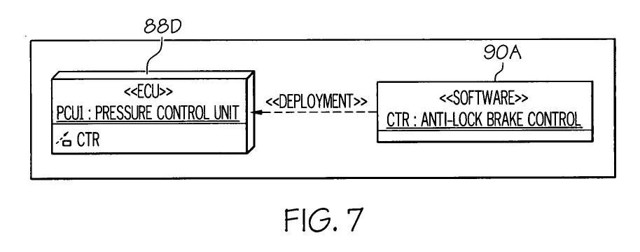

In any event, referring back to FIGS. 1 and 2, once the instances have all been interconnected, parameter setting system 52 can then be used to set up any parameters for the components, as well as to deploy software to the components as needed. It is often the case the physical components require some level of software to achieve a desired functionality. For example, if a desired function for an automobile is an adaptive cruise control that detects objects in front of the automobile, both components (e.g., sensors, a force feedback gas pedal, etc.) and software could be needed to realize the desired function. Referring to FIG. 7, the deployment of software packages to components (or their instances) is shown. Specifically, as shown, software package 90A has been deployed to instance 88D.

Referring back to FIGS. 1 and 2, once parameters have been set up and any software has been deployed, evaluation system 54 can be used to evaluate the configuration 81 to conduct the trade-off study. Such evaluation can include any number of factors such as evaluating a cost model of the configuration, evaluating a development effort of the configuration, analyzing an allocation of the configuration, etc. To this extent, evaluation system 54 could be configured to compute a property such as a cost of the configuration. In addition, in analyzing an allocation of the configuration, evaluation system 54 can ensure that all physical components, as derived from the mapping 70 (FIG. 3), have been addressed (e.g., instances have been created, connected to other instances, etc). This helps ensure that components have not been inadvertently omitted and that the trade-off study is complete.

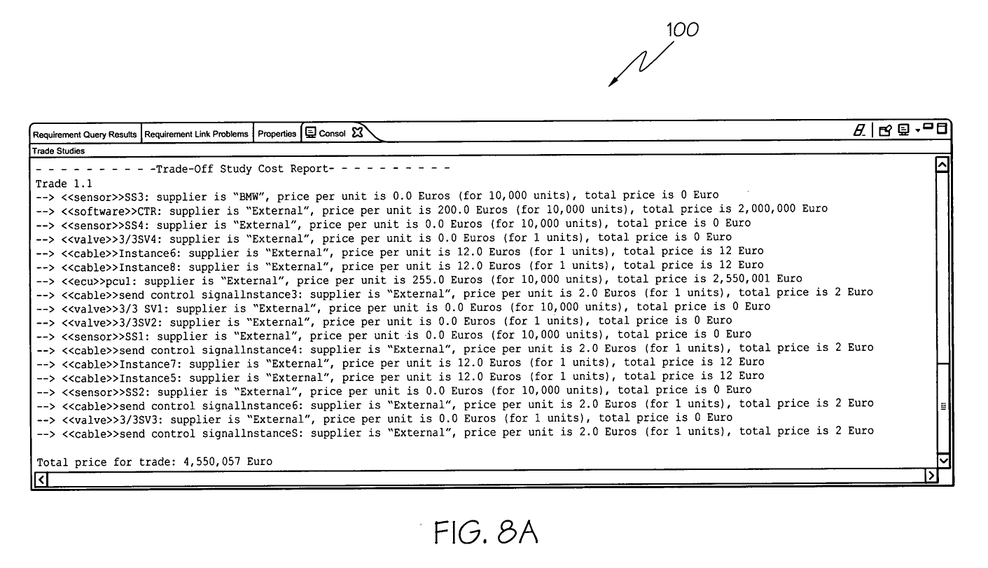

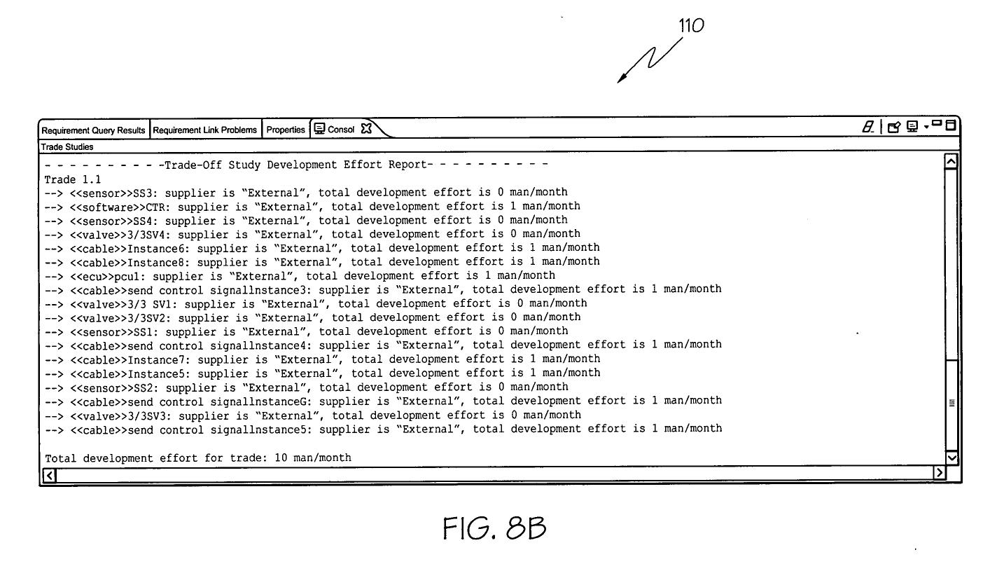

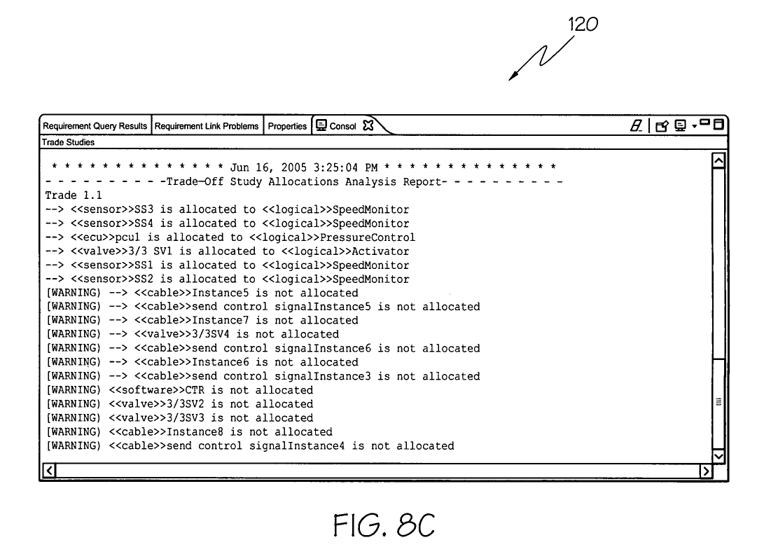

Referring to FIGS. 8A-C, illustrative evaluation output screens are shown. Specifically, FIG. 8A depicts a cost model evaluation report 100 in which costs associated with the configuration are shown. FIG. 8B shows an illustrative development effort report 110 that outlines the approximate time and efforts that will be involved with realizing the product. FIG. 8C shows an illustrative configuration allocation report 120 that outlines any components that have not been allocated. As mentioned above, this indicates that there may be a “gap” between the mapping and the configuration that was actually built.

In any event, referring back to FIGS. 1 and 2, update system 56 can be used to update the semantic component library 16 and/or configuration 81. For example, assume that a cost of a component was updated in its “stereotype” within semantic component library 16. Update system 56 will propagate the update to any configuration(s) using that component. This helps ensure that configuration 81 is always current. In the event that changes are made to semantic component library 16 that would affect the configuration 81 and/or its evaluation, evaluation system 54 will re-evaluate configuration 81 based after such changes have been propagated.

IV. Additional Implementations

While shown and described herein as a method and system for conducting a trade-off study, it is understood that the invention further provides various alternative embodiments. For example, in one embodiment, the invention provides a computer-readable medium (or computer useable medium) that includes computer program code to enable a computer infrastructure to evaluate annotations to content. To this extent, the computer-readable medium or computer useable medium includes program code that implements each of the various process steps of the invention. It is understood that the term “computer-readable medium” or “computer useable medium” comprises one or more of any type of physical embodiment of the program code. In particular, the or computer-readable medium or computer useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to conduct a trade-off study. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for conducting a trade-off study. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for conducting a trade-off study, comprising:
providing a mapping of a logical model to a physical model for a product that is a subject of the trade-off study;
building a configuration for the product using a semantic component library, wherein the semantic component library identifies components for the product and potential connections between the components; and
evaluating the configuration to conduct the trade-off study.

2. The computer-implemented method of claim 1, wherein the logical model comprises a desired functionality for the product, and wherein the physical model comprises at least one component for providing the desired functionality.

3. The computer-implemented method of claim 1, wherein the building step comprises:
selecting a component for the product from the semantic component library;
creating an instance of the component;
graphically connecting the instance with at least one other instance to yield the configuration; and
establishing a set of parameters for the instance.

4. The computer-implemented method of claim 1, wherein the evaluating step comprises computing a property of the configuration.

5. The computer-implemented method of claim 1, wherein the evaluating step comprises verifying that mapping is completely addressed in the configuration.

6. The computer-implemented method of claim 1, further comprising updating the semantic component library based on the evaluating.

7. The computer-implemented method of claim 1, wherein the components comprise parts.

8. The computer-implemented method of claim 1, wherein the components are arranged hierarchically within the semantic component library.

9. A system for conducting a trade-off study, comprising:
a mapping system for providing a mapping of a logical model to a physical model for a product that is a subject of the trade-off study;
a configuration system for building a configuration for the product using a semantic component library, wherein the semantic component library identifies components for the product and potential connections between the components; and
an evaluation system for evaluating the configuration to conduct the trade-off study.

10. The system of claim 9, wherein the logical model comprises a desired functionality for the product, and wherein the physical model comprises at least one component for providing the desired functionality.

11. The system of claim 9, wherein the configuration system comprises:
a component selection system for selecting a component for the product from the semantic component library;
an instance creation system for creating an instance of the component;
an instance connection system for graphically connecting the instance with at least one other instance to yield the configuration; and
a parameters setting system for establishing a set of parameters for the instance.

12. The system of claim 9, further comprising a configuration update system for updating the semantic component library on the evaluating.

13. The system of claim 9, wherein the evaluation system computes a parameter of the configuration, and verifies that the mapping has been fully addressed in the configuration.

14. The system of claim 9, wherein the components comprise parts, and wherein the components are arranged hierarchically within the semantic component library.

15. A program product stored on a computer useable medium for conducting a trade-off study, the computer useable medium comprising program code for causing a computer system to perform the following steps:
providing a mapping of a logical model to a physical model for a product that is a subject of the trade-off study;
selecting a component for the product from a semantic component library, wherein the semantic component library identifies components for the product and potential connections between the components;
creating an instance of the component;
graphically connecting the instance with at least one other instance to yield the configuration;
establishing a set of parameters for the instance; and
evaluating the configuration to conduct the trade-off study.

16. The program product of claim 15, wherein the logical model comprises a desired functionality for the product, and wherein the physical model comprises at least one component for providing the desired functionality.

17. The program product of claim 15, wherein the evaluating step comprises:
evaluating a cost model of the configuration; and
verifying that mapping is completely addressed in the configuration.

18. The program product of claim 15, wherein the computer useable medium further comprises program code for performing the following step: updating the configuration based on the evaluating.

19. The program product of claim 15, wherein the program product is implemented using Unified Modeling Language.

20. A method for deploying an application for conducting a trade-off study, comprising:
providing a computer infrastructure being operable to
provide a mapping of a logical model to a physical model for a product that is a subject of the trade-off study;
build a configuration for the product using a semantic component library, wherein the semantic component library identifies components for the product and potential connections between the components; and
evaluate the configuration to conduct the trade-off study.
